(19) United States
(12) Patent Application Publication
(10) Pub. No.: US 2002/0136223 A1
(43) Pub. Date: Sep. 26, 2002

(54) Method and apparatus for interworking PNNI with the signalling and routing protocols used in MPLS networks

(76) Inventor: Ka K. Ho, Kanata (CA)

Correspondence Address: William B. Vass, c/o Ridout & Maybee, Suite 2400, One Queen Street East, Toronto, ON, M5C 3B1, CA

(21) Appl. No.: 09/739,271

(22) Filed: Dec. 19, 2000

(51) Int. Cl. H04L 12/28

(52) U.S. Cl. 370/395.51; 370/466

(57) ABSTRACT

A method and system for interfacing a Multi-Protocol Label Switching (MPLS) protocol based network to an Asynchronous Transfer Mode (ATM) network using the Private Network-Network Interface standard and providing routing and signalling interworking between the networks. The system comprises ATM aware Label Switching Routers (LSRs) at the edge of an MPLS network. Each of the ATM aware LSRs run entities according to the PNNI protocol To interconnect the PNNI entities running on the ATM aware LSRs. Abstract trunks are created from groups of CR-LSPs (Constraint-based Routed-Label Switched Paths). The creation of the CR-LSPs is dynamic and Virtual Path Connections (VPCs) and Virtual Channel Connections (VCCs) are transported on the CR-LSPs. Using network topology information from a Link State Interior Gateway Protocol (IGP) with Traffic Engineering extensions, the representation of the MPLS network topology is translated into a PNNI representation which is exported from the MPLS network to exterior ATM networks running PNNI In another aspect, PNNI is extended to comprise a label distribution protocol through the addition of a new Label Information Element (IE).

### FIELD OF THE INVENTION

The present invention relates to digital networks and voice/data communication systems, and more particularly to a method and apparatus for interfacing a Multiprotocol Label Switching (MPLS) network to a Private Network-Network Interface (PNNI) protocol network for routing and signalling interworking with Asynchronous Transfer Mode (ATM) networks

### BACKGROUND OF THE INVENTION

Multiprotocol Label Switching or MPLS is a technology under development by the Internet Engineering Task Force (IETF) that attempts to merge label-based switching with network layer routing. MPLS encompasses new signalling protocols such as Label Distribution Protocol (LDP) which are used to create connections over a network and uses network layer routing protocols (either existing or new protocols) to route these connections. MPLS is expected to be the core network technology for carrying data traffic over the Internet. MPLS can simplify the forwarding of traffic thereby potentials improving scalability and reducing equipment costs

One issue with the migration to MPLS protocol based networks is support for existing, i.e. legacy. Asynchronous Transfer Mode (ATM) networks Private Network-Network Interface (PNNI) is an ATM forum standard for handling signalling and routing in ATM networks.

Known approaches for supporting legacy ATM networks include: providing multiple control planes on every network element, terminating ATM traffic, or the creation of pipes through the MPLS network to carry ATM traffic without passing knowledge of the topology of the underlying MPLS network to the PNNI network

Accordingly, there remains a need for a technique which allows MPLS to efficiently support legacy ATM networks. In particular, the subject invention described herein supports interworking PNNI with the signalling and routing protocols that can be used with MPLS networks.

### BRIEF SUMMARY OF THE INVENTION

The present invention provides a mechanism for carrying Asynchronous Transfer Mode (ATM) data over a Multiprotocol Label Switching (MPLS) based network. The mechanism comprises ATM aware LSRs (Label Switched Routers) at the edge of the MPLS network. According to this aspect of the invention, the ATM aware LSRs run PNNI entities To interconnect the ATM aware LSRs, groups of CR-LSPs (Constraint based Routed - Label Switched Path) are created dynamically between these ATM aware LSRs forming “Abstract Trunks” ATM Virtual Path Connections (VPCs) and Virtual Channel Connections (VCCs) are transported on these CR-LSPs.

Certain forms of ATM traffic, such as AAL-5 traffic (ATM Adaptation Layer Type 5) in particular, can be more efficiently transported than with normal ATM provided that a lightweight L2 (Layer 2) protocol such as PPP (Point-to-Point Protocol) is used. According to one aspect, the present invention utilizes carrying ATM over MPLS using a lightweight Layer 2 encapsulation protocol such as PPP to reduce the overhead associated with the ATM header and padding for AAL-5 traffic. The ATM cells transporting packet traffic via AAL-5 are first reassembled into the AAL-5 CPCS-PDU (Common Part Convergence Sublayer-Protocol Data Unit). The CPCS-PDU is then carried over MPLS/PPP thereby eliminating the overhead associated with padding and potentially reducing the ATM header overhead. AAL-1 (ATM Adaptation Layer Type 1) and AAL-2 (ATM Adaptation Layer Type 2) traffic can be carried by encapsulation although the same efficiency improvement is not obtained for these forms of traffic.

Advantageously, the mechanism according to the present invention maintains the auto-detection capabilities of PNNI while remaining inter-operable with conventional Label Switched Routers (LSRs).

In one aspect of the invention, the topological representation of the MPLS network obtained from using a Link State Interior Gateway Protocol with Traffic Engineering extensions is translated into a representation that can be understood by a conventional ATM network running PNNI routing. Advantageously, this can improve PNNI routing decisions made by exterior conventional ATM networks running PNNI.

In another aspect, the signalling portion of the PNNI protocol is extended to become a label distribution protocol by the addition of an information Element or IE which is used to carry label assignments

According to another aspect of the invention, the PNNI signalling protocol is interworked to permit connections to be established from exterior ATM networks over the MPLS network. Advantageously, this allows the invention to handle connection requests from existing ATM networks that run PNNI on legacy equipment.

In a first aspect, the present invention provides in a communication system comprising a multi-protocol label switching network and at least one asynchronous transfer mode network, a system for interfacing the multi-protocol label switching network to the asynchronous transfer mode network for interworking between the networks, the system comprises (a) a plurality of ATM aware label switched routers, the label switched routers are configured at an interface between the multi-protocol label switching network and the asynchronous transfer mode network; (b) each of the ATM aware label switched routers operates according to a protocol compatible with the asynchronous transfer mode network for establishing a connection with the asynchronous transfer mode network for carrying traffic between the networks; (c) a component for establishing interior connections between the ATM aware label switched routers in the multi-protocol label switching network, and the interior connections comprise trunks created dynamically for transporting the data traffic through the multi-protocol label switching network.

In another aspect, the present invention provides a method for interworking between a multi-protocol label switching network and an asynchronous transfer mode network, the method comprises the-steps of: (a) providing a plurality of ATM aware label switched routers at an interface between the multi-protocol label switching network and the asynchronous transfer mode network; (b) operating each of the ATM aware label switched routers according to a protocol compatible with the ATM asynchronous network, (c) utilizing the ATM aware label switched routers to establish a connection between the asynchronous transfer mode network and the multi-protocol label switching network for carrying data traffic between the networks; (d) establishing interior connections between one or more of the ATM aware label switched routers in the multi-protocol label switching network; and (e) the interior connections comprise dynamically creating trunks for transporting the data traffic; through the multi-protocol label switching network between the selected ATM aware label switched routers.

In yet another aspect, the present invention provides a system for interfacing a multi-protocol label switching network to an asynchronous transfer mode network for interworking between the networks, the system comprises (a) a plurality of ATM aware label switched routers, the label switched routers are configured at an interface between the multi-protocol label switching network and the asynchronous transfer mode network; (b) each of the ATM aware label switched routers operating according to a protocol compatible with the asynchronous transfer mode network; (c) means for establishing interior connections between the ATM aware label switched routers in the multi-protocol label switching network, and the interior connections comprise trunks created dynamically between selected ATM aware label switched routers for routing traffic through the multi-protocol label switching network

In a further aspect, the present invention provides a mechanism for translating a representation of the topology for the multi-protocol label switching network to a PNNI network representation. The mechanism comprises a component for generating PNNI node representations for the ATM aware label switched routers and a component for representing links in the multi-protocol label switching network as physical links in the PNNI network representation The mechanism further includes a component for generating PNNI node representations of non-ATM aware label switched routers wherein the non-ATM aware label switched routers are located inside the multi-protocol label switching network.

### BRIEF DESCRIPTION OF THE DRAWINGS

Reference will now be made to the accompanying drawings, which show, by way of example, a preferred embodiment of the present invention, and in which:

FIG. 1 shows in diagrammatic form a network arrangement according to the present invention;

FIG. 2 shows in diagrammatic form an Abstract trunk arrangement for the network of FIG. 1;

FIG. 3 shows in schematic form exemplary parameters for the CR-LSPs for the Abstract trunk of FIG. 2;

FIG. 4 shows in diagrammatic form an ATM shim label for identifying the final destination end-point for ATM traffic transported over MPLS according to another aspect of the present invention,

FIG. 5 shows in diagrammatic form an example of translating the representation of the MPLS network into a PNNI network representation according to another aspect of the present invention;

FIG. 6 shows in diagrammatic form the structure of an Information Element for distributing labels according to another aspect of the present invention; and

FIG. 7 shows in diagrammatic form the operation of two ATM aware LSRs to establish an ATM connection through a MPLS network according to the present invention.

### DETAILED DESCRIPTION OF THE PREFERRED EMBODIMENT

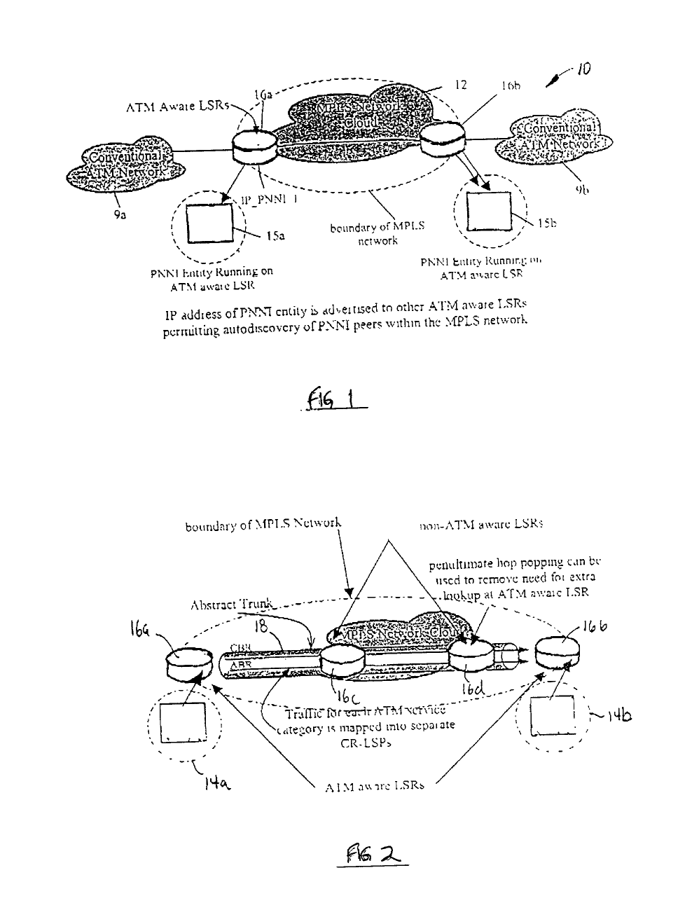

Reference is first made to FIG. 1, which shows in diagrammatic form a network arrangement according to the present invention, and indicated generally by reference 10. The network arrangement comprises a MPLS network 12 which is shown with two ATM aware LSRs 16, shown individually as 16a and 16b, on the edge of the MPLS network 12. The ATM aware LSRs 16a and 16b each run a PNNI entity 15a and 15b, respectively. The ATM aware LSPs, shown at the edge of the MPLS network 12, can be interfaced with external ATM networks 9a and 9b running PNNI for establishing ATM connections as will be described in more detail below. While the network configuration is described with two ATM aware LSRs it will be understood that the network arrangement according to the present invention is applicable to more than two ATM aware LSRs, for example, 100 or more ATM aware LSRs

The ATM aware LSRs 16 operating on the edge of the MPLS network 12 run PNNI (Private Network-Network Interface) entities. The PNNI protocol comprises two aspects, a link state routing protocol, and a signalling protocol. The routing protocol is responsible for distributing topology information which is used to determine routes within the ATM network. The signalling protocol, on the other hand, is used to construct point-to-point and point-to-multipoint connections across the ATM network. As will be described, the network transport arrangement 10 according to the present invention utilizes the PNNI protocol as a component in the interface between ATM networks and MPLS networks 12.

According to this aspect, the ATM aware LSRs 16 at the edge of the MPLS network 12 run PNNI entities 15 The PNNI entities 15 on the ATM aware LSRs 16 interact with exterior ATM networks using the standard PNNI protocol The PNNI entities on the ATM aware LSRs 16 are assigned “virtual interface” Internet Protocol (IP) addresses which belong to a specific group of IP addresses identified by one or more IP prefixes. These IP prefixes are established through configuration of the ATM aware LSRs 16 in the MPLS network 12. The ATM aware LSRs 16 with the MPLS network 12 discover their peers within the MPLS network 12 when the IP addresses of the corresponding PNNI entities 15 are advertised by an Interior Gateway Protocol or IGP. It will be appreciated that LSRs in the interior of the MPLS network 12 do not have knowledge of the external ATM networks 9 and therefore do not need to run PNNI protocol entities. Advantageously, this reduces the processing requirements within the interior of the MPLS network 12 and also improves the scalability of the network transport arrangement 10. As a further advantage, Label Switch Routers (LSRs) of conventional design, i e non ATM aware LSRs 16, may be used in the core of MPLS network 12

Reference is next made to FIG. 2 ATM data is transported using Constraint-based Routed Label Switched Paths or CR-LSPs. ATM traffic of different service categories is segregated into different CR-LSPs. As shown in FIG. 2, a collection of CR-LSPs from one ATM aware LSR 16a to another ATM aware LSR 16b forms one direction of a bi-directional link. In the context of the present invention, the set of CR-LSPs between two ATM aware LSRs 16 comprises an Abstract trunk denoted by 18. If there are CR-LSPs in both the direction from the ATM aware LSRs 16a to 16b and the direction from the ATM aware LSRs 16b to 16a, then the Abstract Trunk 18 would be bi-directional. Several Abstract trunks 18 may be used in parallel between two ATM aware LSRs 16, and as such represent the different routing costs of different CR-LSPs in the MPLS network 12

The Abstract trunk 18 carries ATM traffic between two ATM aware LSRs 16 without regards to the ultimate destination endpoint of the data by means of a hierarchy. In the label stack of a labelled MPLS packet traversing Abstract Trunk 18, a label at another level of the stack is used to identify the destination interface, or the destination ATM interface cards and connection endpoint of the traffic. It will be appreciated that this arrangement allows different VPCs (Virtual Path Connections) and VCCs (Virtual Channel Connections) to share one Constraint-based Routed-Label Switched Path (CR-LSP), even if they terminate on different ATM interface cards Preferably, all CR-LSPs which terminate on the IP address of a PNNI entity (i.e. an ATM aware LSR) utilize ‘penultimate hop popping’ in order to remove the need for additional label lookup and label pop operations at the ATM aware LSP 16 at the egress of the CR-LSP.

To preserve the Label Switch Path Identifier (LSPID) space of each ATM aware LSR 16, the IP address of the PNNI entity 15 for the ATM aware LSR 16 is used as the source of the ATM carrying CR-LSPs in the Abstract trunk 18 when building the LSPIDs for the CR-LSPs of the Abstract trunk 18. To be consistent with this arrangement, the final hop of an ‘explicit route’ of an ATM bearing CR-LSP is the IP address of the PNNI entity 15 being run by the ATM aware LSR 16 at the destination end of the CR-LSP in the trunk 18 In the preferred embodiment, each component (i.e. CR-LSP) of the Abstract trunk 18 is operationally independent from the other. It is thus possible that a VBR bearing CR-LSP from ATM aware LSR 16a to ATM aware LSR 16b is different in capacity than a VBR bearing CR-LSP operating in the opposite direction. Additionally, there is no restriction on the number of CR-LSPs which may be used to carry a single category of traffic on the Abstract trunk 18. The explicit routes for these CR-LSPs may be determined with topology information from an Interior Gateway Protocol or IGP with Traffic Engineering (TE) or QoS extensions as will be familiar to one skilled in the art

According to this aspect of the network transport arrangement or system 10, the CR-LSPs that form the Abstract trunk 18 are dynamically created and dynamically removed when they are no longer needed For example, when an ATM call Setup request is signalled, from an ATM network connected to 16a, the receiving PNNI entity 15 for the ATM aware LSR 16a may either find an existing CR-LSP in the Abstract trunk 18 with sufficient capacity, or enlarge an existing CR-LSP, or construct a new CR-LSP for the Abstract trunk 18 in order to transport the new data traffic. Preferably, the default parameters for constructing new CR-LSPs are configured into an ATM aware LSR on a per ATM service category basis as shown in FIG. 3 in the context of the ATM aware LSRs 16a and 16b. For each PNNI entity peer, the ATM aware LSR 16 stores a group of CR-LSPs that exist to carry traffic of a specific ATM service category to and from a peer. This includes CR-LSPs that both originate and terminate at the ATM aware LSR 16 as also shown in FIG. 3 For a given direction of an ATM connection, connection admission control or CAC is performed against the characteristics of a CR-LSP in the direction for the appropriate ATM service category To preserve in order delivery, only one CR-LSP is considered for carrying the connection when performing CAC for a connection in a given direction.

To carry ATM traffic over an Abstract trunk, via the CR-LSPs as described above, cell payloads for AAL-1 and AAL-2 type data traffic streams are transported in the form of directly encapsulated labelled MPLS packets For AAL-5 ATM traffic, the ATM cells are reassembled back into CPCS-PDUs accompanied with portions of the CPCS-PDU trailer, in particular the CPCS-UU field, the CPI field, and the Length field The CPCS-UU field is used to transparently carry user-to-user data. The CPI field is preferably included since it may be used to carry layer management messages. The Length field contains the length of the CPCS-PDU payload field.

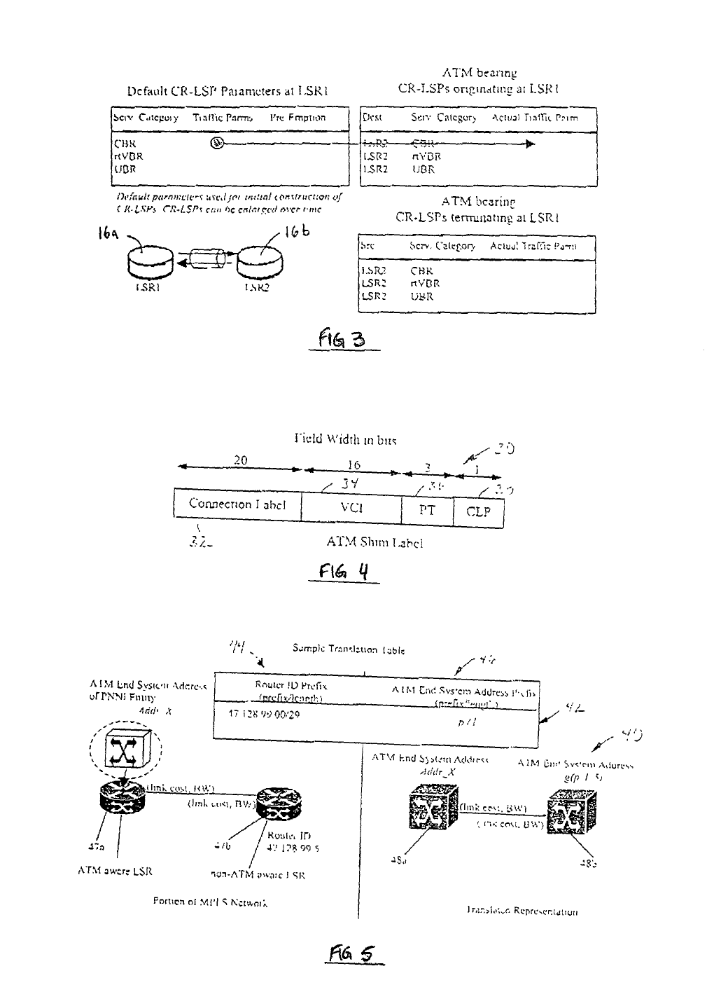

The labels of a MPLS labelled packet are arranged into a label stack. The encapsulation of ATM cells (or CPCS-PDUs for AAL-5 traffic) for transport in a MPLS packet uses three labels in the label stack The topmost label corresponds to the CR-LSP that is used to transport the MPLS packet between the ATM aware LSRs 16. The label beneath the top of the label stack corresponds to the final destination ATM interface or ATM interface card for the traffic These first two labels can be encoded using standard MPLS encoding techniques such as described by Rosen, et al. in MPLS Label Stack Encoding. IETF Draft, September 1999. The bottom label comprises an ATM shim label 30 as shown in FIG. 4.

The ATM shim label 30 identifies the final destination end-point for the ATM connection. As shown in FIG. 4, the ATM shim label 30 comprises a header which is based on the format of an ATM standard header, and includes a connection label 32, a VCI (Virtual Circuit identifier) field 34, a PT field 36, and a CLP field 38. The destination ATM interface or ATM interface card uses the connection label 32 to determine the VPI (Virtual Path Identifier) for VPCs (Virtual Path Connections) and the VPI and VCI for VCCs (Virtual Channel Connections). In the case of VPCs, the VCI field 34 is used to identify the VCIs for ATM VCCs that are contained in the VPC For VCCs, the VCI field 34 is unused and may be left as a default value such as 0. The PT and CLP fields are as defined in the standard ATM header.

In operation when a MPLS labelled packet arrives on a CR-LSP at the ATM aware LSR 16 that is the endpoint of the CR-LSP, penultimate hop popping should preferably have already removed the label corresponding to the transporting CR-LSP This exposes the next label in the label stack, i.e. the label corresponding to the final destination ATM interface or ATM interface card for the ATM traffic The LSR can use this label to forward the labelled packet to the correct ATM interface or ATM interface card. At the destination interface or interface card, the ATM shim label 30 is used to reconstruct the original ATM cell stream. As noted above. the connection label 32 is used to determine the VPI for VPCs and the VPI and VCI for VCCs. In the case of VPCs, the VCI field 34 is used to identify the VCIs for ATM VCCs that are contained in the VPC

The mechanism for carrying ATM traffic over the Abstract trunk 18 as described above also supports the tandem transport of ATM traffic through two CR-LSPs. Tandeming of the ATM traffic is accomplished by setting a forwarding entry within the ATM aware LSR at the conjunction of the two tandem CR-LSPs for the destination ATM interface label (or ATM interface card label) in order to direct the MPLS labelled packet to another CR-LSP This technique is used if the underlying IGP in the MPLS network is hierarchical

PNNI RCCs may be transported via UDP/IP (User Datagram Protocol/Internet Protocol). The PNNI signalling channel requires reliable transport and conventionally rides over the Signalling ATM Adaptation Layer (SAAL) which includes a Service Specific Coordination Function (SSCF), the Service Specific Connection Oriented Protocol (SSCOP) and AAL-5. TCP/IP may be used to provide reliable transport or alternatively SSCF and SSCOP can be preserved over UDP transport

Preferably, the PNNI RCC and signalling channel traffic will be carried encapsulated with IP and transported over the CR-LSPs established between the PNNI entities 15 running on the ATM aware LSRs 16 This arrangement provides some measure of protection for traffic control. The CR-LSPs for control traffic are signalled by the ATM aware LSRs 16 upon auto-detection of another ATM aware LSR 16 using preconfigured traffic parameters The CR-LSPs for the PNNI RCC and signalling channels act as tunnels. As described above, penultimate hop hopping is used and a label at another level of the MPLS label stack is used to identify control traffic

The label to identify control traffic can be handled in one of two ways. First, a label may be reserved for control traffic destined for the PNNI entity on ATM aware LSRs. Alternatively, the reserved Explicit Null IPv4 (or IPv6) label may be pushed on the stack as the last entrap before the IP header. In either case, the IP source address of the encapsulating IP packet is the IP address of the originating PNNI entity, and the IP destination address is the IP address of the remote PNNI entity. Accordingly, a TCP port is reserved for signalling traffic and either a UDP or TCP port is reserved for the RCC.

To preserve the semantics of the PNNI protocol running on the ATM aware LSRs 16, each PNNI entity 15 being run maintains a block of port IDs. Upon establishing a “Hello” session with a remote PNNI entity running on an ATM aware LSR 16, one of the port IDs is assigned to the Hello session.

Flooding is the technique used in PNNI to distribute topology information across a peer group.

It will be appreciated that if a large number of PNNI entities are connected in a mesh via RCCs, the amount of traffic from flooding could become overwhelming. One of the features according to the present invention is to divide PNNI entities into flooding and non-flooding entities Flooding entities perform initial topology exchange and flood PNNI topology information conventionally. Non-flooding PNNI entities also perform Initial topology exchange conventionally but flood topology information only towards flooding PNNI entities Flooding and non-flooding PNNI entities are assigned IP addresses with different common IP address prefixes. However, any given PNNI entity is configured with the IP prefixes identifying both flooding and non-flooding entities, and is thus aware of both flooding and non-flooding entities. Advantageously, this arrangement of flooding and non-flooding PNNI entities improves scalability by reducing the total amount of topology information flooded to support the PNNI routing protocol in the network transport arrangement 10.

According to another aspect of the invention, the representation of the topology of the MPLS network 12 is translated into a PNNI network representation which is then exported to external ATM networks. The ATM aware LSRs 16, as described above, can acquire the entire topology of the MPLS network 12, in particular, links and link bandwidths via a Link State IGP with Traffic Engineering (TE) or QoS extensions. In this aspect, the ATM aware LSRs 16 are represented as PNNI nodes with an ATM End System Address of the respective PNNI entity 15 running on the ATM aware LSR 16 The ATM End System Addresses are 20 octets long with the initial 19 octets used for PNNI routing. The 20^{th} octet, i.e referred to as the selector, has only local significance. The PNNI Node Identifier can be constructed from the ATM End System Address in accordance with the PNNI V1.0 standard, Private Network-Network Interface Specification Version 1.0, ATM Forum, March 1996. For the non-ATM aware LSRs, a mapping function is used to translate their IGP router IDs to an ATM End System Address. Although translated ATM End System Addresses are produced for non-ATM aware LSRs, these addresses exist only for the purpose of constructing PNNI node Identifiers. An example of such a mapping function is described in more detail below.

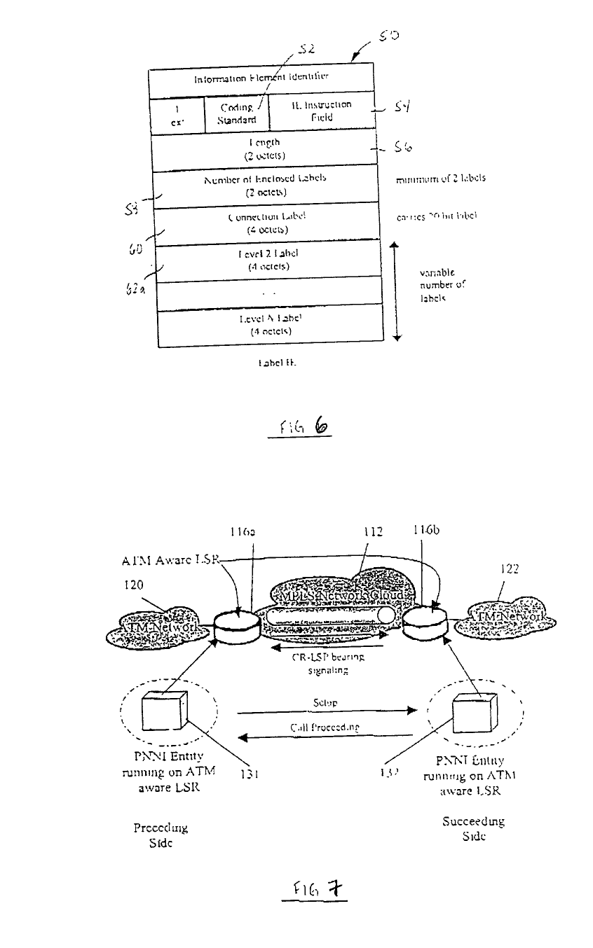

Reference is next made to FIG. 5, which shows in diagrammatic form a process for translating the representation of the topology of a portion of a MPLS network into a PNNI network representation. In FIG. 5, a portion of the MPLS network is represented on the left hand side, and the translated PNNI network representation is shown on the right hand side and indicated by reference 40 As described above, the ATM aware LSRs are represented as PNNI nodes with the ATM End System Address of the respective PNNI entity running on the ATM aware LSR. Following this rule for FIG. 5, the ATM aware LSR 47a is represented as PNNI node 48a with the same ATM End System Address as the PNNI entity running on the ATM aware LSR 47a. For non-ATM aware LSRs, a preferred mapping function of this invention involves converting the router IDs of non-ATM aware LSRs with a common prefix into ATM End System Addresses with a common prefix using a translation table. In the context of the present invention, a router ID prefix is defined as a router ID and some indication of the leftmost contiguous significant bits of the prefix. A router ID is said to match a router ID prefix if the significant bits of the prefix are the same as the bits of the router ID. For a given translation table, the best router prefix ID match for a router ID is the router ID prefix of the longest length that the router ID matches. As shown in FIG. 5, the translation table 42 comprises router ID prefixes indicated by reference 44 and corresponding ATM End System Address prefixes 46. When a best match router ID prefix 44 is found in the translation table 42 for a router ID, the remaining non-significant bits ignored during the match are used along with the associated ATM End System Address prefix 46 in the translation table 42 to create a unique ATM End System Address for any of the translated PNNI nodes representing non-ATM aware LSRs as indicated by reference 48b in FIG. 5. A function such as g(p,l,ns) constructs an ATM End System Address from the ATM End System Address prefix p, which has a length/and from the non-significant bits ns from the router ID prefix match described above. Such a function can operate by combining the first l bits of prefix p and the non-significant bits ns to form the first 19 octets of the ATM End System Address and then appending a 2^{th} octet (i.e. the selector) Since the selector has only local significance, its value can be left as a default value such as zero. It will be appreciated that the above approach is only one possible example of a function to construct an ATM End System Address.

The actual physical links in the MPLS network are represented as physical links in the PNNI representation. The link costs used by the IGP (Interior Gateway Protocol) for these physical links also has to be translated to PNNI costs. This may be done utilizing a user configurable arithmetic expression. For example in FIG. 5, the link costs and link bandwidth associated with the output side of a LSR interface, or a translated PNNI node interface, is represented as a pair of the form (cost, bandwidth)

From the perspective of external PNNI networks, an Abstract trunk 18 is represented as a physical link. As the CR-LSPs that comprise an Abstract Trunk 18 are created, enlarged, or removed, the physical link representing the Abstract Trunk 18 is adjusted to reflect the transport capability of the CR-LSPs. Capacity consumed by the CR-LSPs on the actual physical links of the MPLS network is removed when translating the representation of the MPLS topology to a PNNI representation.

It will be appreciated that in the PNNI protocol, a Designated Transit List or DTL is a complete path across a peer group comprising a sequence of node IDs and optional port IDs which traverse the peer group. As described above, an Abstract trunk only couples ATM aware LSRs. However, PNNI nodes outside of the MPLS network can generate DTLs that contain the PNNI node IDs of non-ATM aware LSRs or that contain more than two ATM aware LSRs In order to use a tunnel model to carry ATM traffic, it is necessary to prevent transiting more than two ATM aware LSRs. Consider a DTL which takes the following form:

{ , P_{F}, . . . , P_{L}, ,}

where:

P_{F} is the first PNNI node ID in the DTL which identifies a PNNI entity running on an ATM aware LSR

P_{L} is the last PNNI node ID in the DTL which identifies a PNNI entity running on an ATM aware LSR

It will be appreciated that there may be zero or more PNNI node IDs preceding the first PNNI node ID, between P_{F} and P_{L} and after P_{F} within the DTL

When processing a DTL of the form described above for a Call Setup operation, any PNNI node IDs between P_{F} and P_{L} are skipped. However, should a call Setup attempt be blocked at either of the ATM aware LSRs corresponding to P_{F} and P_{L} , then the link between P_{F} to the next, node ID in the DTL is identified as the blocking link. Since the PNNI entities running on the ATM aware LSRs corresponding to P_{F} and P_{L} store the correct call state to reflect the DTL bypass, call release may be handled by the aforementioned PNNI entities

According to another aspect of the invention, an information element or IE is provided for the ATM aware LSRs 16 to distribute labels corresponding to ATM interfaces (or ATM interface cards) and labels for connection identifiers. The Information Element is referred to as the Label IE. The Information Element comprises a structure 50 as shown in FIG. 6, and as shown, includes a Coding Standard field 52, an IE instruction field 54, a Length field 56, a Number of Enclosed Labels field 58, a Connection Label field 60, and a variable number of Level “N” Label fields 62 In particular, the Coding Standard 52 may comprise Coding Standard “11”, i.e. the “standard defined for the network, either public or private, present on the network side of the interface” according to ITU-T-Q 2931, the IE Instruction Field 54 is coded as zeros, and the Information Element Identifier is assigned a new number not currently used by UNI or PNNI.

The Information Element 50 is intended for signalling between two ATM aware LSRs. It is to be understood that the IE 50 is not intended for interacting with conventional ATM switches. As such IE 50 does not need to follow the conventional coding rules provided in the ATM standards, such as the Private Network-Network Interface Specification Version 1.0, ATM Forum, March 1996. As shown in FIG. 6, the IE 50 contains a stack of at least two labels, the Connection Label in field 60 and the ATM destination interface, or the destination interface card label, in the Level 2 Label field 62a. The label for the ATM destination interface, or destination interface card, in field 62a is the first instance in the variable number of Label fields 62. For generality, the Label IE 50 may contain labels in addition to the Label field 62a in the variable number of Label fields 62. The ATM destination interface in field 62a in the first instance in the variable number of Label fields 62. It will be appreciated that the ATM destination interface labels specified in the field 62 have local scope within the ATM aware LSR. The scope of the connection labels may be limited further to the scope of an ATM interface or ATM destination interface card. Each 4 octet entry for a label in field 60 or 62a comprises a 20 bit value which is consistent with the currently published standard MPLS Label Stack Encoding, IETF Draft, September 1999, Rosen, et al.

The operation of two ATM aware LSRs to establish an ATM connection between two ATM networks through a MPLS network according to the present invention is considered with reference to FIG. 7. The ATM aware LSRs are indicated by references 116a and 116b, respectively, and are configured at the edge of the MPLS network 112. The ATM aware LSR 116a interfaces the MPLS network 112 to an ATM network denoted by reference 120, and the ATM aware LSR 116b interfaces the MPLS network 112 to another ATM network denoted by reference 122. The PNNI entity 131 that signals the call Setup and the associated ATM aware LSR 116a is referred to as being on the preceding side. The PNNI entity 132 that receives the call Setup and its associated ATM aware LSR is referred to as being on the succeeding side. The PNNI entity 131 issues a call Setup message which includes a Label Information Element (IE) as described above with reference to FIG. 6. The Information Element 50 carries the labels 60, 62 which will be used by the ATM aware LSR 116b on the succeeding side in order to send traffic towards the ATM aware LSR 116a on the preceding side. In response to the call Setup message, the PNNI entity 132 (i e. on the succeeding side) replies with a “call Proceeding” message. The call Proceeding message contains an Information Element (IE) (as described above with reference to FIG. 6). The Information Element contains the labels 60, 62 which will be used by the ATM aware LSR 116a on the preceding side to send data traffic through the MPLS network 112 to the ATM aware LSR 116b on the succeeding side. When a “call Release” message is signalled according to the PNNI protocol for the ATM connection, the connection labels defined in the Information Elements 50 are effectively withdrawn The ATM interface label (or ATM interface card label), i.e. as defined in field 62 of the IE 50 (FIG. 6), is withdrawn when the last connection that uses the ATM interface label (or ATM interface card label) is released.

According to another aspect, the mechanism is extendable to a MPLS network with a hierarchical Interior Gateway Protocol (IGP) by mapping partitions within the IGP into PNNI peer groups.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. In a communication system comprising a multi-protocol label switching network and at least one asynchronous transfer mode network, a system for interfacing the multi-protocol label switching network to the asynchronous transfer mode network for interworking routing and signalling between the networks, said system comprising:
(a) a plurality of ATM aware label switched routers, said ATM aware label switched routers being configured at an interface between the multi-protocol label switching network and the asynchronous transfer mode network,
(b) each of said ATM aware label switched routers operating according to a routing and signalling protocol compatible with the asynchronous transfer mode network for establishing a connection for carrying traffic between the networks;
(c) a component for establishing interior connections between the ATM aware label switched routers in the multi-protocol label switching network, and said interior connections comprising trunks created dynamically between selected ATM aware label switched routers for transporting traffic through the multi-protocol label switching network

2. The system as claimed in claim 1, wherein said routing and signalling protocol for the asynchronous transfer mode network comprises private network-network interface protocol or PNNI protocol, and said ATM aware label switched router includes a component for running the PNNI protocol as an entity.

3. The system as claimed in claim 2, wherein said PNNI entity component for the ATM aware label switched router includes an Internet Protocol address

4. The system as claimed in claim 2, wherein said dynamically created trunks comprise one or more constraint based routed-label switched paths.

5. The system as claimed in claim 2, further including an information element component, said information element component including a plurality of fields for storing label assignments for distribution between said PNNI entity components running on said ATM aware label switched routers.

6. The system as claimed in claim 2, further including a mechanism for translating a representation of the topology for the multi-protocol label switching network to a PNNI network representation, and said mechanism comprising a component for generating PNNI node representations for said ATM aware label switched routers and a component for representing links in the multi-protocol label switching network as physical links in said PNNI network representation.

7. The system as claimed in claim 6, wherein said mechanism for translating a representation of the topology for the multi-protocol label switching network includes a component for generating PNNI node representations of non-ATM aware label switched routers, said non-ATM aware label switched routers being located inside said multi-protocol label switching network.

8. A method for interworking traffic between a multi-protocol label switching network and an asynchronous transfer mode network, said method comprising the steps of:
(a) providing a plurality of ATM aware label switched routers at an interface between the multi-protocol label switching network and the asynchronous transfer mode network;
(b) operating each of said ATM aware label switched routers according to a routing and signalling protocol compatible with the asynchronous transfer mode network:
(c) utilizing said ATM aware label switched routers to establish a connection between the asynchronous transfer mode network and the multi-protocol label switching network for carrying data traffic between the networks,
(d) establishing interior connections between one or more of the ATM aware label switched routers in the multi-protocol label switching network; and
(e) said interior connections comprising dynamically creating trunks for transporting the data traffic through the multi-protocol label switching network between selected ATM aware label switched routers

9. The method as claimed in claim 8, wherein said compatible routing and signalling protocol comprises a private network-network interface or PNNI protocol, and said ATM aware label switched router runs an entity for the PNNI protocol.

10. The method as claimed in claim 9 wherein said step of dynamically creating trunks comprises providing one or more constraint based routed label switched paths.

11. The method as claimed in claim 8, further including a step for translating a representation of the topology for tho multi-protocol label switching network to a PNNI network representation, and said step includes generating PNNI node representations for said ATM aware label switched routers and representing links in the multi-protocol label switching network as physical links in said PNNI network representation.

12. The method as claimed in claim 11, wherein said step for translating a representation of the topology for the multi-protocol label switching network includes generating PNNI node representations of non-ATM aware label switched routers, said non-ATM aware label switched routers being located inside said multi-protocol label switching network

13. A system for interfacing a multi-protocol label switching network to an asynchronous transfer mode network for interworking traffic between the networks, said system comprising:
(a) plurality of ATM aware label switched routers, said label switched routers being configured at an interface between the multi-protocol label switching network and the asynchronous transfer mode network;
(b) each of said ATM aware label switched routers operating according to a routing and signalling protocol compatible with the asynchronous transfer mode network;
(c) means for establishing interior connections between the ATM aware label switched routers in the multi-protocol label switching network, and said interior connections comprising trunks created dynamically between selected ATM aware label switched routers for routing traffic through the multi-protocol label switching network.

14. The system as claimed in claim 13, wherein said routing and signalling protocol for the asynchronous transfer mode network comprises private network-network interface protocol or PNNI protocol, and said ATM aware label switched router includes means for running the PNNI protocol as an entity.

15. The system as claimed in claim 14, wherein said means for running the PNNI protocol as an entity includes an Internet Protocol address.

16. The system as claimed in claim 14, wherein said dynamically created trunks comprise one or more constraint based routed label switched paths

17. The system as claimed in claim 13, further including means for translating a representation of the topology for the multi-protocol label switching network to a PNNI network representation, and means for translating including means for generating PNNI node representations for said ATM aware label switched routers and means for representing links in the multi-protocol label switching network as physical links in said PNNI network representation

18. The system as claimed in claim 17, wherein said means for translating a representation of the topology for the multi-protocol label switching network includes means for generating PNNI node representations of non-ATM aware label switched routers, said non-ATM aware label switched routers being located inside said multi-protocol label switching network.
